(19) United States
(12) Patent Application Publication
(10) Pub. No.: US 2020/0200720 A1
(43) Pub. Date: Jun. 25, 2020

(54) OPTICAL DETECTOR FLOW CELL FOR CO2-BASED CHROMATOGRAPHY

(71) Applicant: Waters Technologies Corporation, Milford, MA (US)

(72) Inventors: Michael O. Fogwill, Uxbridge, MA (US); Sebastien Besner, Bolton, MA (US); Scott Kelley, Brookline, MA (US); Joseph Michienzi, Plainville, MA (US)

(73) Assignee: Waters Technologies Corporation, Milford, MA (US)

(21) Appl. No.: 16/718,859

(22) Filed: Dec. 18, 2019

Related U.S. Application Data
(60) Provisional application No. 62/782,585, filed on Dec. 20, 2018.

(51) Int. Cl. G01N 30/74; B01D 15/10

(52) U.S. Cl. CPC G01N 30/74; G01N 2030/025; B01D 15/10

(57) ABSTRACT

The present disclosure relates to optical flow cells for use in chromatography or extraction systems. The optical flow cells include an inlet portion configured to receive a highly compressible fluid and an inlet transition portion or gasket having an internal volume and internal geometry configured to receive the highly compressible fluid from the inlet portion. The optical flow cell also includes an optical path portion configured to receive the highly compressible fluid from the inlet transition portion and direct the highly compressible fluid along an optical flow path. The internal volume and the internal geometry of the inlet transition portion configured to minimize turbulence and eddies within the highly compressible fluid as it travels through the optical flow path.

### CROSS-REFERENCE TO RELATED APPLICATIONS

This application claims the benefit of and priority to U.S. Provisional Patent Application No. 62/782,585 filed Dec. 20, 2018 titled “OPTICAL DETECTOR FLOW CELL FOR CO₂-BASED CHROMATOGRAPHY,” the entire contents of which is hereby incorporated by reference in its entirety.

### FIELD OF THE TECHNOLOGY

The present disclosure generally relates to flow cells for pressurized chromatography or extraction systems. In particular, the present disclosure relates to optical detector flow cells.

### BACKGROUND

Chromatography involves the flowing of a mobile phase over a stationary phase to effect separation. To speed-up and enhance the efficiency of the separation, pressurized mobile phases are introduced. Carbon dioxide based chromatographic systems use CO₂ as a component of the mobile phase flow stream, and the CO₂ based mobile phase is delivered from pumps and carried through the separation column as a pressurized liquid. The CO₂ based mobile phase is used to carry components of the analytes in a sample through the chromatography column and to a detection system.

### SUMMARY

Performing optical detection within a chromatography or extraction system raises a number of challenges, especially when dealing with a highly compressible mobile phase, such as a CO₂-based mobile phase. Technology for avoiding pressure changes within an optical detector would be beneficial and highly desirable.

According to one aspect of the present technology, an optical flow cell is disclosed. The optical flow cell includes an inlet portion configured to receive a highly compressible fluid. The optical flow cell also includes an inlet transition portion having an internal volume and internal geometry configured to receive the highly compressible fluid from the inlet portion. The optical flow cell also includes an optical path portion configured to receive the highly compressible fluid from the inlet transition portion and direct the highly compressible fluid along an optical flow path. The internal volume and the internal geometry of the inlet transition portion are configured to minimize turbulence and eddies within the highly compressible fluid as it travels through the optical flow path. In a non-limiting example, an internal thickness of the inlet transition portion is configured to reduce turbulence and eddies within the highly compressible fluid as it travels through the optical flow path. In another non-limiting example, the inlet portion is configured to introduce the highly compressible fluid into the inlet transition portion at an angle configured to reduce turbulence and eddies within the highly compressible fluid. In another non-limiting example, the inlet transition portion has an annular internal geometry configured to direct the highly compressible fluid along an annular flow path. In another non-limiting example, the annular internal geometry is oriented around a central axis of the optical path portion. In another non-limiting example, the optical flow cell also includes an end portion configured to direct the annular flow path inward toward a central axis of the inlet transition portion and reverse a flow direction of the highly compressible fluid prior to directing the highly compressible fluid along the optical flow path. In another non-limiting example, the inlet transition portion has a substantially spiraling internal geometry. In another non-limiting example, the inlet transition portion has a greater internal volume proximal to the optical flow portion than proximal to the inlet portion. In another non-limiting example, the optical flow cell also includes a light source configured to direct light along the optical flow path. In another non-limiting example, the inlet transition portion is a gasket.

According to another aspect of the present technology, another optical flow cell is disclosed. The optical flow cell includes an inlet portion configured to receive a highly compressible fluid. The optical flow cell also includes an annular inlet transition portion having a substantially cylindrical internal volume and configured to receive the highly compressible fluid from the inlet portion. The optical flow cell also includes an optical path portion configured to receive the highly compressible fluid from the annular inlet transition portion and direct the highly compressible fluid along an optical flow path. In a non-limiting example, the optical flow cell also includes a conical portion configured to direct the highly compressible fluid toward a central axis of the optical path portion. In another non-limiting example, at least a part of the optical path portion is disposed within a cavity defined by the annular inlet transition portion. In another non-limiting example, the optical flow cell also includes an end portion configured to direct the highly compressible fluid inward toward a central axis of the inlet transition portion and reverse a flow direction of the highly compressible fluid prior to directing the highly compressible fluid along the optical flow path. In another non-limiting example, the inlet transition portion is a gasket.

According to another aspect of the present disclosure, another optical flow cell is disclosed. The optical flow cell includes an inlet portion configured to receive a highly compressible fluid. The optical flow cell also includes an inlet transition portion having a spiraling internal geometry and configured to receive the highly compressible fluid from the inlet portion. The optical flow cell also includes an optical path portion configured to receive the highly compressible fluid from the inlet transition portion and direct the highly compressible fluid along an optical flow path. In a non-limiting example, the inlet transition portion has a larger internal volume proximal to the optical path portion than proximal to the inlet portion. In another non-limiting example, the inlet transition portion is a gasket.

The above aspects of the technology provide numerous advantages. For example, the various designs and geometries disclosed herein can prevent eddies within the CO₂-based mobile phase and therefore prevent localized pressure changes and changes in the refractive index of the fluid due to density variation. Overall, this invention increases the signal to noise ratio of optical detection when used with a CO₂-based mobile phase.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a cross section of an example prior art CO₂-based flow cell, which was derived from a LC detector.

FIG. 2 is a representation of a predicted flow pattern of a mobile phase comprised of 10% methanol in CO₂ flowing through the flow cell of FIG. 1 at 2 mL/min.

FIG. 3 shows an example portion of an optical detector flow cell with an inlet transition portion, according to an embodiment of the present disclosure.

FIG. 4 shows an example portion of an optical detector flow cell with a spiral inlet transition portion, according to an embodiment of the present disclosure.

FIG. 5 shows an example portion of an optical detector flow cell with an expanding inlet transition portion, according to an embodiment of the present disclosure.

FIG. 6 shows an example portion of an optical detector flow cell with an angled inlet transition portion, according to an embodiment of the present disclosure.

FIG. 7 shows an example portion of an optical detector flow cell with an angled inlet transition portion, according to an embodiment of the present disclosure.

FIG. 8 shows a cross sectional view of an example optical detector flow cell with a reverse sheath inlet transition portion, according to an embodiment of the present disclosure.

FIG. 9 shows a transparent perspective view of an example optical detector flow cell with a sheath inlet transition portion, according to an embodiment of the present disclosure.

FIG. 10 is model of the mobile phase flowing through a flow cell designed with a thin inlet transition portion, according to an embodiment of the present disclosure.

FIG. 11 is a model of the mobile phase flowing through a flow cell designed with a thick inlet transition portion, according to an embodiment of the present disclosure.

FIG. 12 is a model of the mobile phase flowing through a flow cell designed with a spiral inlet transition portion, according to an embodiment of the present disclosure.

FIG. 13 is a side view of a model of the mobile phase flowing through a flow cell designed with a reverse inlet transition portion, according to an embodiment of the present disclosure.

FIG. 14 is another view of a model of the mobile phase flowing through a flow cell designed with a reverse inlet transition portion, according to an embodiment of the present disclosure.

The features and advantages of the present disclosure will become more apparent from the detailed description set forth below when taken in conjunction with the drawings.

### DETAILED DESCRIPTION

Following below are more detailed descriptions of various concepts related to, and embodiments of optical detector flow cells for use within a chromatography system. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

Optical detection involves passing light through flow cell containing a sample and measuring the amount of light absorbed by the sample. Example detectors include ultraviolet visible (UV-Vis) detectors and photodiode array (PDA) detectors. Each operate on Beer's law (Equation 1)

A=εlC (1)

A is the dimensionless absorbance, ε is a molar absorptivity coefficient (L mol⁻¹ cm⁻¹), l is the light path (cm) length, and C is the concentration (mol L⁻¹) of the analyte. Absorbtivity is an analyte-dependent physical constant. Accordingly, to increase absorbance, the path length of light within the detector cell can be increased, or the concentration of the analyte can be increased. Path length is often limited to by mechanical or manufacturing constraints and/or optimal volumes dictated by chromatographic performance. Concentration, on the other hand, is governed by amount injected and mobile phase flow rate. The amount injected and the mobile phase flow rate have an inverse relationship, so it can be challenging to optimize these parameters to improve detector response. For example, large flow rates allow for large injection volumes (pre-column dilution to avoid mass and volume overload). Optimizing the response of optical detectors can be achieved by maximizing the signal to noise ratio generated by the amount injected. Accordingly, in addition to efforts to maximize the signal generated, efforts to reduce the baseline noise of the detector have a very impactful effect on detector performance.

Changes in the refractive index (RI) of a fluid inside the optical path of the detector cell can also result in undesired detector noise. Such changes are tolerable if they occur infrequently, or change slowly. However, changes in fluid RI on the time scale of a chromatographic peak are very undesirable for low-noise, sensitive detection. In comparison to liquid chromatography (LC), supercritical fluid chromatography (SFC) employing a highly compressible, often CO₂-based, mobile phase has a greater number of possible variables affecting the RI of the mobile phase. For example, the RI is related to the density of the mobile phase. Since density is controlled by temperature and pressure, these parameters have a direct influence on the RI of the mobile phase. Accordingly, pressure and temperature fluctuations can contribute to high levels of detector noise and must be managed in for CO₂-based chromatography with optical detection.

Modern CO₂-based chromatography systems are often designed to reduce system pressure noise and to thermally pre-condition the mobile phase prior to entry into the flow cell. However, the optical detector flow cells are largely unchanged from the LC cells they were derived from. Most commonly, the cell is modified with an increased pressure rating to accommodate the pressurized nature of the SFC mobile phase.

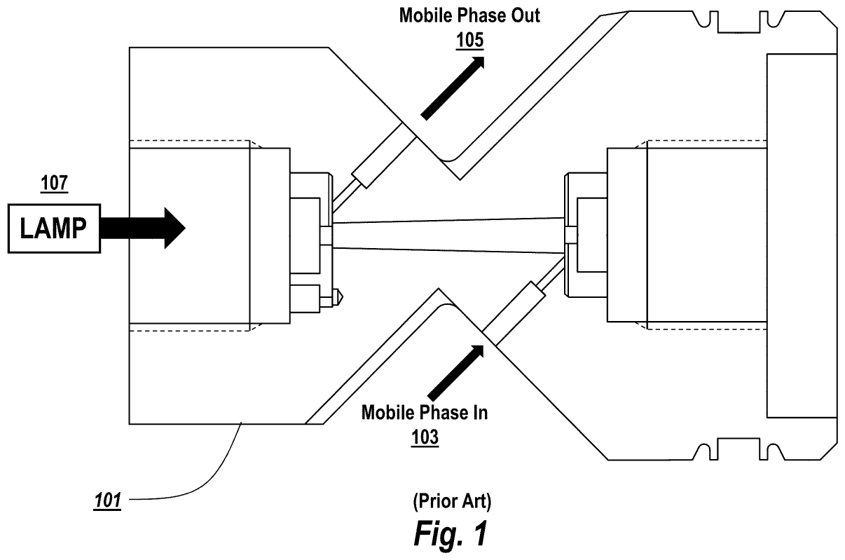

FIG. 1 is a cross section of an example prior art CO₂-based flow cell 101, which was derived from a LC detector. A problem arises from such cell design because the cell was not designed with a compressible mobile phase in mind. In this example, the flow cell 101 includes a mobile phase inlet 103 and a mobile phase outlet 105, as well as a lamp 107 configured to pass light through the mobile phase flow path. The low viscosity and compressible nature of the CO₂-based mobile phase both promote turbulent flow and the formation of eddies or turbulence within the optical path of the flow cell.

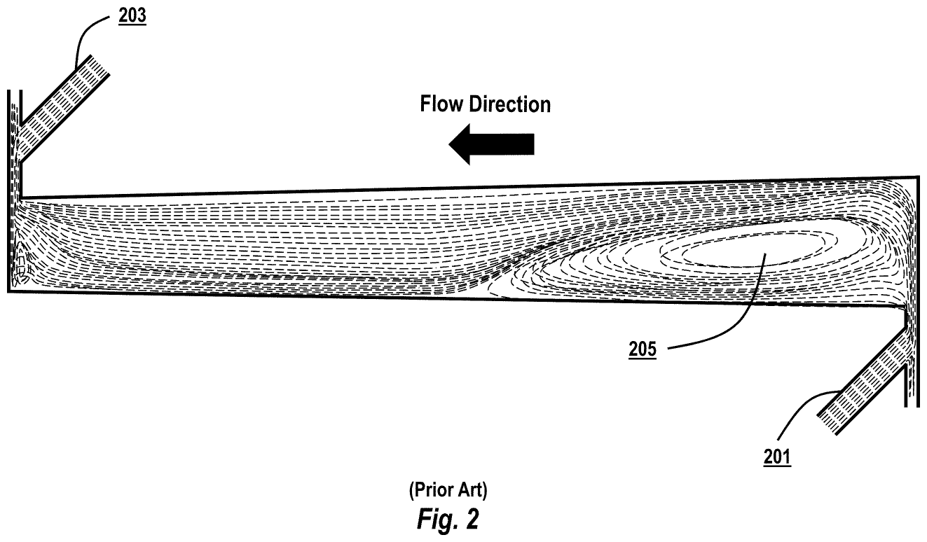

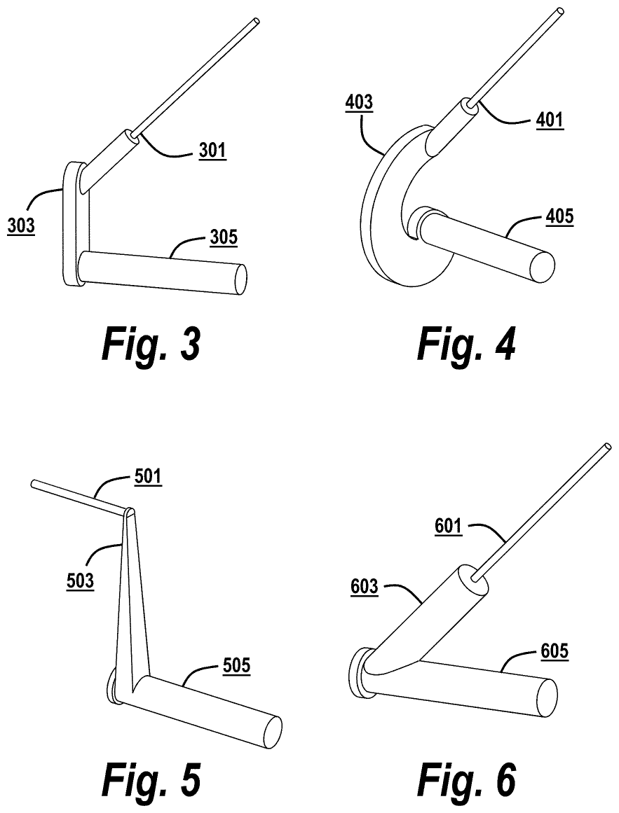

An example of the formation of flow eddies or turbulence is shown in FIG. 2. This figure is a representation of a predicted flow pattern of a mobile phase comprised of 10% methanol in CO₂ flowing through the cell 200 at 2 mL/min. This example flow cell 200 includes a fluid inlet 201 and a fluid outlet 203. Note the circular flow pattern or eddy 205 on the right side of the optical path. Such eddying causes problems for optical detection since it promotes localized changes in the pressure of the fluid. Since RI is directly related to the density, which, in turn is related to pressure, eddy formation translates into high baseline noise. To mitigate and minimize the effects of eddies and turbulence on CO₂-based detector noise, novel flow cell geometries have been developed. Strategies to eliminate sharp angles or corners in the flow path, minimize velocity differences of the fluid, and decrease changes in cross-sectional area of the flow path all work to reduce or eliminate the formation of eddies and turbulent flow. Such eddies and turbulent flow should be reduced in the optical path portion of the detector flow cell. Accordingly, strategies to move the eddies away from the optical path, instead of eliminating them entirely are also viable solutions. FIGS. 3-9 show a number of non-limiting examples of flow cell geometries. The example designs shown in these figures work to eliminate eddying or to move the eddy to a region outside the optical path.

FIG. 3 shows an example portion of an optical detector flow cell with an inlet transition portion 303, according to an embodiment of the present disclosure. In a non-limiting example embodiment, the inlet transition portion 303 can be a gasket, or some other suitable transition device. For the sake of simplicity, the inlet transition portions described herein can be referred to as gaskets, but may be other transition devices other than gaskets. This example design minimizes mobile phase velocity changes (i.e. maintains a constant cross-sectional area) and reduces the sharp angles/corners that the fluid must pass through. In a non-limiting example, the flow cell includes an inlet portion 301 that is angled to introduce the fluid into the inlet gasket 303 at about 45°, and an optical path portion 305. As discussed in more detail below, the thickness or interior volume of the inlet gasket 303 can be configured to adjust the fluid flow and minimize eddies or turbulence that can cause localized pressure changes in a CO₂-based mobile phase.

FIG. 4 shows an example portion of an optical detector flow cell with a spiral inlet gasket 403, according to an embodiment of the present disclosure. This example design also minimizes sharp mobile phase velocity changes (i.e. maintains a constant cross-sectional area) and reduces the sharp angles/corners by having a spiraling inlet transition portion or gasket 403 between the inlet portion 401 and the optical path portion 405. The spiraling inlet gasket 403 provides for a gradual change in cross-sectional area from the inlet portion 401 and the optical path portion 405 which allows for a gradual change in fluid velocity and minimizes the formation of eddies and turbulent flow. In a non-limiting example, the inlet portion 401 is angled to introduce the fluid into the inlet gasket 303 at about 45°.

FIG. 5 shows an example portion of an optical detector flow cell with an expanding inlet transition portion or gasket 503, according to an embodiment of the present disclosure. This example design minimizes sharp mobile phase velocity changes and eddies within the flow cell by having an expanding inlet gasket 503 that has a larger interior volume near the optical path portion 505 than the inlet portion 501.

FIG. 6 shows an example portion of an optical detector flow cell with an angled inlet gasket 603, according to an embodiment of the present disclosure. This example design minimizes mobile phase velocity changes and eddies within the flow cell by having the angled inlet gasket 603 direct fluid from the inlet portion 601 into the optical path portion 605 at an angle that is not orthogonal to the optical path portion 605.

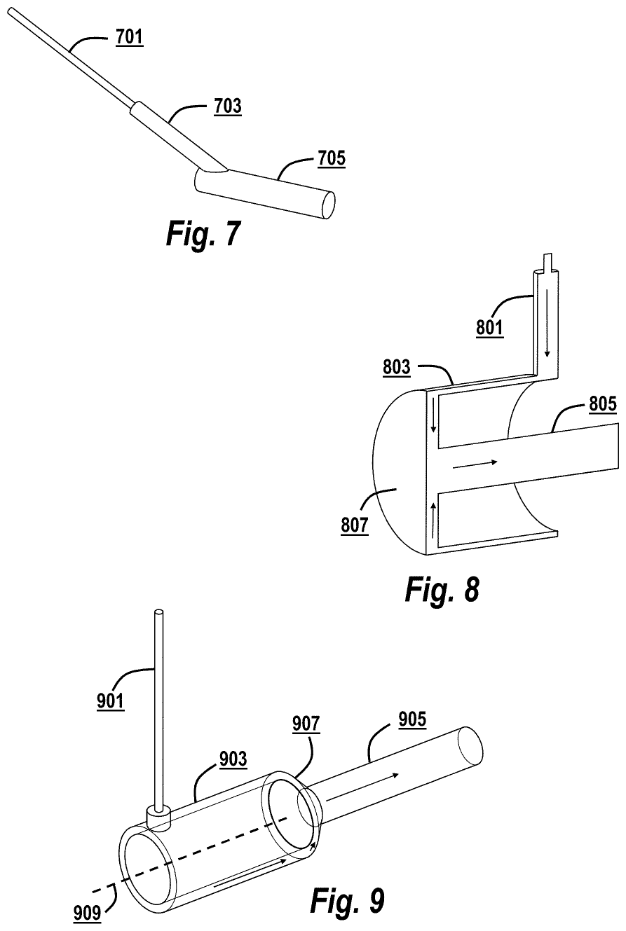

FIG. 7 shows an example portion of an optical detector flow cell with an angled inlet gasket 703, according to an embodiment of the present disclosure. Similar to the example shown in FIG. 6, this design minimizes mobile phase velocity changes and eddies within the flow cell by having the angled inlet gasket 703 direct fluid from the inlet portion 701 into the optical path portion 705 at an angle that is not orthogonal to the optical path portion 705. However, in this non-limiting example an obtuse angle is formed between the angled inlet gasket 703 and the optical flow path 705, rather than an acute angle.

FIG. 8 shows a cross sectional view of an example optical detector flow cell with a reverse sheath inlet gasket 803, according to an embodiment of the present disclosure. In a non-limiting example, the fluid enters the reverse sheath portion 803 of the optical detector flow cell through an inlet portion 801. In this embodiment, the reverse sheath portion 803 is an annular or cylindrical channel that distributes the fluid flow in an annular flow path toward an end portion 807. Once the fluid reaches the end portion 807, the fluid is directed inward toward the optical path portion 805. In a non-limiting example, the cross-sectional area of the reverse sheath portion 803, the end portion 807, and the optical path portion 805 are substantially equivalent.

FIG. 9 shows a transparent perspective view of an example optical detector flow cell with a sheath inlet gasket 903, according to an embodiment of the present disclosure. In a non-limiting example, the fluid enters the sheath portion 903 of the optical detector flow cell through an inlet portion 901. In this embodiment, the sheath portion 903 is an annular or cylindrical channel having a central axis 909 that distributes the fluid flow in an annular flow path toward conical portion 907. Once the fluid reaches the conical portion 907, the fluid is directed inward toward the central axis 909 and through the optical path portion 905. In a non-limiting example, a light source of the optical detector can be positioned at either end of the flow cell and can be configured to direct light through the optical path portion 905 along the central axis 909.

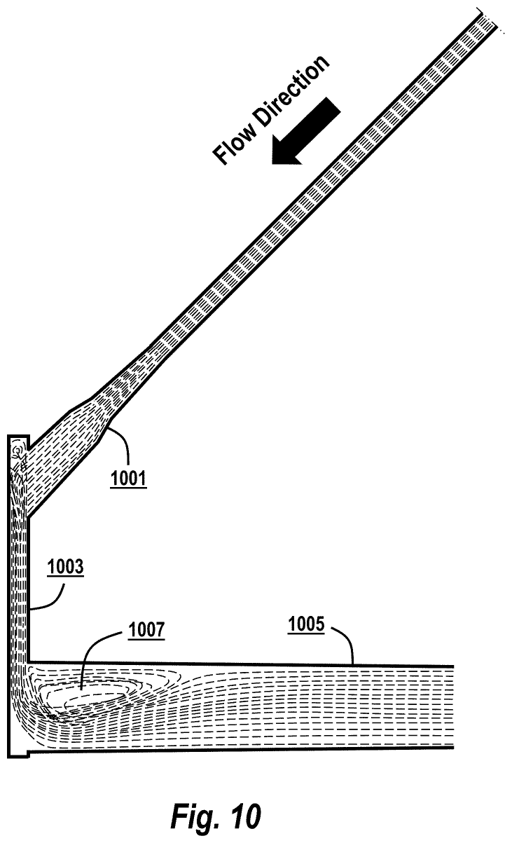

FIG. 10 is model of the mobile phase flowing through a flow cell designed with a thin inlet gasket 1003, according to an embodiment of the present disclosure. In a non-limiting example, the thin inlet gasket 1003 has a thickness of 0.005″, and the mobile phase enters the thin inlet gasket 1003 through an inlet portion 1001 at an angle. The mobile phase then flows through the thin inlet gasket 1003 and enters the optical path portion 1005. In this example, however, eddies 1007 can be generated where the mobile phase exits the thin inlet gasket 1003 and enters the optical path portion 1005 of the flow cell.

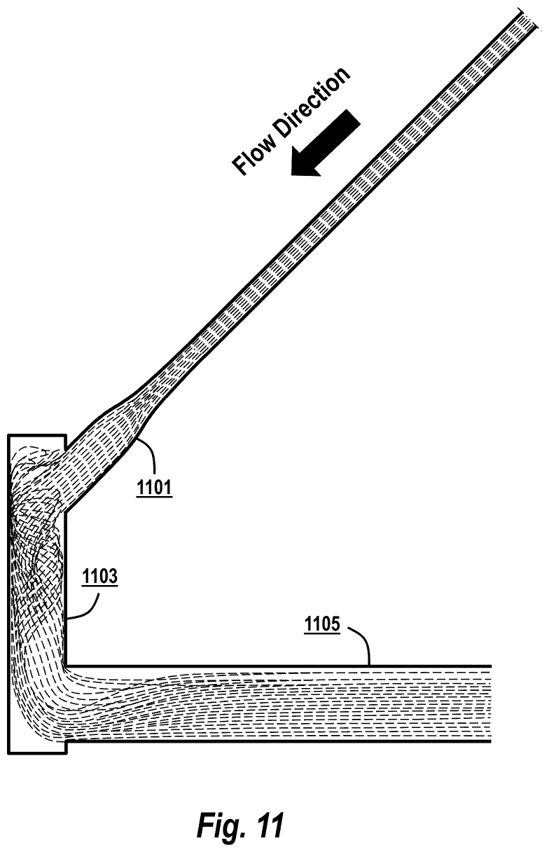

FIG. 11 is a model of the mobile phase flowing through a flow cell designed with a thick inlet gasket 1103, according to an embodiment of the present disclosure. In a non-limiting example, the inlet gasket 1103 is designed with an increased thickness of 0.015″ in order to reduce or eliminate eddies formed within the optical path portion 1005. As can be seen in this example, the mobile phase enters the thick inlet gasket 1103 from an inlet portion 1101 and more smoothly enters the optical path portion 1105 without forming the eddies seen in the example shown in FIG. 10. In a non-limiting example, the larger interior volume or cross sectional area of the thick inlet gasket 1103 allows the mobile phase to more smoothly enter and flow through the optical path portion, thus reducing the localized pressure changes and changes in refractive index caused by eddies. The larger interior volume of the thick inlet gasket 1103 can minimize the change in velocity of the mobile phase as it enters the optical path portion 1105 and may help minimize eddy formation.

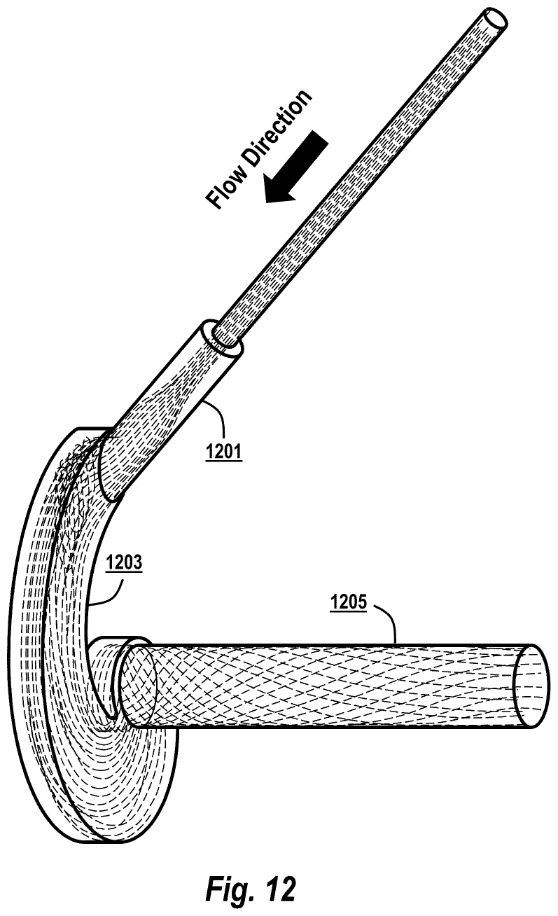

FIG. 12 is a model of the mobile phase flowing through a flow cell designed with a spiral inlet gasket 1203, according to an embodiment of the present disclosure. In a non-limiting example, the mobile phase enters the spiral inlet gasket 1203 through an inlet portion 1201 at an angle and can flow through the spiraling inner volume until it enters the optical path portion 1205. This example embodiment may help the mobile phase enter the optical path portion 1205 in a more uniform and symmetrical fashion. Instead of all of the mobile phase entering from one side of the optical path, the spiral gasket 1203 was designed to have the mobile phase enter the optical path portion 1205 in a more radially-homogeneous fashion. As can be seen in the model shown in FIG. 12, no eddying is visible and there is a gradual change in fluid velocity as the mobile phase enters the optical path portion 1205.

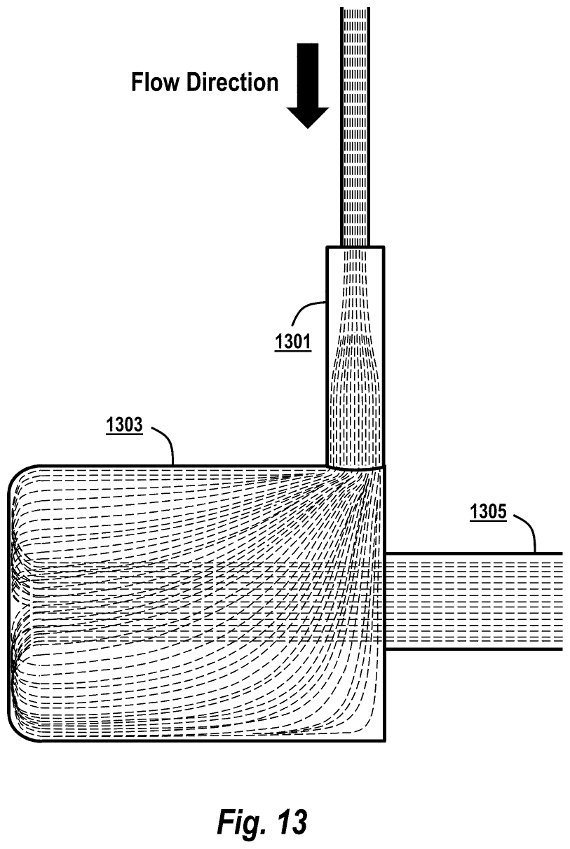

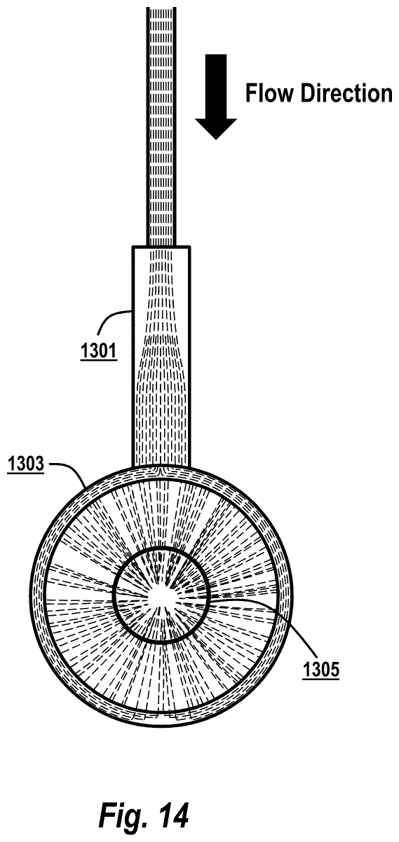

FIG. 13 is a side view of a model of the mobile phase flowing through a flow cell designed with a reverse inlet gasket 1303, according to an embodiment of the present disclosure. In a non-limiting example, the mobile phase enters the reverse inlet gasket 1303 through an inlet portion 1301 and is directed around the annular inner volume of the reverse inlet gasket 1303, as described above in reference to FIG. 8. Once the mobile phase reaches the end of the reverse inlet gasket 1303, it is directed inward and reverses direction as it enters the optical path portion 1305. FIG. 14 is another view of the model of FIG. 13 seen along the axis of the optical path portion 1305, according to an embodiment of the present disclosure. The models shown in FIGS. 13-14 show excellent symmetry, no obvious eddying, and minimal velocity changes. Further, the modeling seems to imply very smooth fluid flow through the optical path portion 1305.

One skilled in the art will recognize that the flow direction and the direction of the light through the flow cell can be in the same direction or in opposite directions. The optical bore may be a taper slit or a straight-through design. The outlet cross sectional area of the optical bore may be matched to the inlet cross sectional area for optimal light throughput. The inlet and outlet cross sections may not be the same geometry. For example, the inlet may have a round cross section while the outlet may have a rectangular cross section.

An important aspect of flow cell design is to minimize swept and unswept volumes in the chromatographic mobile phase flow path. Minimizing these volumes is important to maintain chromatographic peak fidelity. Further, inlet and outlet tubing can be arranged in a ‘knitted’ geometry. Such consecutive left and right turns help to minimize band broadening due to longitudinal diffusion in a laminar flow profile.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methodologies, if such features, systems, articles, materials, kits, and/or methodologies are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. An optical flow cell comprising:
an inlet portion configured to receive a highly compressible fluid;
an inlet transition portion having an internal volume and internal geometry configured to receive the highly compressible fluid from the inlet portion; and
an optical path portion configured to receive the highly compressible fluid from the inlet transition portion and direct the highly compressible fluid along an optical flow path, the internal volume and the internal geometry of the inlet transition portion configured to minimize turbulence and eddies within the highly compressible fluid as it travels through the optical flow path.

2. The optical flow cell of claim 1, wherein an internal thickness of the inlet transition portion is configured to reduce turbulence and eddies within the highly compressible fluid as it travels through the optical flow path.

3. The optical flow cell of claim 1, wherein the inlet portion is configured to introduce the highly compressible fluid into the inlet transition portion at an angle configured to reduce turbulence and eddies within the highly compressible fluid.

4. The optical flow cell of claim 1, wherein the inlet transition portion has an annular internal geometry configured to direct the highly compressible fluid along an annular flow path.

5. The optical flow cell of claim 4, wherein the annular internal geometry is oriented around a central axis of the optical path portion.

6. The optical flow cell of claim 4, further comprising an end portion configured to direct the annular flow path inward toward a central axis of the inlet transition portion and reverse a flow direction of the highly compressible fluid prior to directing the highly compressible fluid along the optical flow path.

7. The optical flow cell of claim 1, wherein the inlet transition portion has a substantially spiraling internal geometry.

8. The optical flow cell of claim 1, wherein the inlet transition portion has a greater internal volume proximal to the optical flow portion than proximal to the inlet portion.

9. The optical flow cell of claim 1, further comprising a light source configured to direct light along the optical flow path.

10. The optical flow cell of claim 1, wherein the inlet transition portion is a gasket.

11. An optical flow cell comprising:
an inlet portion configured to receive a highly compressible fluid;
an annular inlet transition portion having a substantially cylindrical internal volume and configured to receive the highly compressible fluid from the inlet portion; and
an optical path portion configured to receive the highly compressible fluid from the annular inlet transition portion and direct the highly compressible fluid along an optical flow path.

12. The optical flow cell of claim 11, further comprising a conical portion configured to direct the highly compressible fluid toward a central axis of the optical path portion.

13. The optical flow cell of claim 11, wherein at least a part of the optical path portion is disposed within a cavity defined by the annular inlet transition portion.

14. The optical flow cell of claim 13, further comprising an end portion configured to direct the highly compressible fluid inward toward a central axis of the inlet transition portion and reverse a flow direction of the highly compressible fluid prior to directing the highly compressible fluid along the optical flow path.

15. The optical flow cell of claim 11, wherein the inlet transition portion is a gasket.

16. An optical flow cell comprising:
an inlet portion configured to receive a highly compressible fluid;
an inlet transition portion having a spiraling internal geometry and configured to receive the highly compressible fluid from the inlet portion; and
an optical path portion configured to receive the highly compressible fluid from the inlet transition portion and direct the highly compressible fluid along an optical flow path.

17. The optical flow cell of claim 16, wherein the inlet transition portion has a larger internal volume proximal to the optical path portion than proximal to the inlet portion.

18. The optical flow cell of claim 16, wherein the inlet transition portion is a gasket.
